(19) United States
(12) Patent Application Publication
(10) Pub. No.: US 2017/0225690 A1
(43) Pub. Date: Aug. 10, 2017

(54) WEARABLE DEVICE CONTROLLED VEHICLE SYSTEMS

(71) Applicant: GENERAL MOTORS LLC, DETROIT, MI (US)

(72) Inventors: Hassan A. Elnajjar, Dearborn, MI (US); Aditya S. Kamini, Bloomfield Hills, MI (US)

(21) Appl. No.: 15/019,568

(22) Filed: Feb. 9, 2016

(51) Int. Cl. B60W 50/10

(52) U.S. Cl. CPC B60W 50/10

(57) ABSTRACT

An example of a system to control an in-vehicle system includes a wearable device, a vehicle communications platform operatively disposed in a vehicle, a control module in communication with the vehicle communications platform, and the in-vehicle system. The wearable device is for recognizing a hand gesture. The vehicle communications platform is for receiving an in-vehicle system request in response to authentication of the hand gesture, and for transmitting the in-vehicle system request to the control module upon receiving the in-vehicle system request. The control module is for transmitting an in-vehicle system command to the in-vehicle system upon receiving the in-vehicle system request from the vehicle communications platform. The in-vehicle system is responsive to the in-vehicle system command from the control module.

### TECHNICAL FIELD

The present disclosure relates generally to wearable device controlled vehicle systems.

### BACKGROUND

Vehicles are often equipped with systems that improve the driving experience. Examples of vehicle systems that improve the driving experience include a trunk open/close system, a lift gate control system, a window up/down system, a sunroof open/closed system, an interior lighting system, a door lock/unlock system, an ignition/power system, an infotainment system, and a climate control system.

### SUMMARY

An example of a system to control an in-vehicle system includes a wearable device, a vehicle communications platform operatively disposed in a vehicle, a control module in communication with the vehicle communications platform, and the in-vehicle system. The wearable device is for recognizing a hand gesture. The vehicle communications platform is for receiving an in-vehicle system request in response to authentication of the hand gesture, and for transmitting the in-vehicle system request to the control module upon receiving the in-vehicle system request from the wearable device. The control module is for transmitting a command to the in-vehicle system upon receiving the in-vehicle system request from the vehicle communications platform. The in-vehicle system is responsive to the in-vehicle system command from the control module.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic view of an example of a system to control an in-vehicle system; and

FIG. 2 is a flow diagram illustrating an example of a method for controlling an in-vehicle system.

### DETAILED DESCRIPTION

Examples of the method and system disclosed herein utilize a wearable device to control in-vehicle systems. As such, they improve the function of the vehicle by enabling a user to control in-vehicles systems from inside or outside the vehicle. The wearable device recognizes a hand gesture that the user performs. In some examples, the wearable device authenticates the hand gesture and transmits an in-vehicle system request to the vehicle communications platform. In other examples, the wearable devices transmits the hand gesture data to a server or a mobile communications device, and the server or the mobile communications device authenticates the hand gesture and transmits the in-vehicle system request to the vehicle communications platform. Once the vehicle communications platform receives that in-vehicle system request, it transmits the request to the appropriate control module. The control module transmits a command to an in-vehicle system, and the in-vehicle system is responsive to the command.

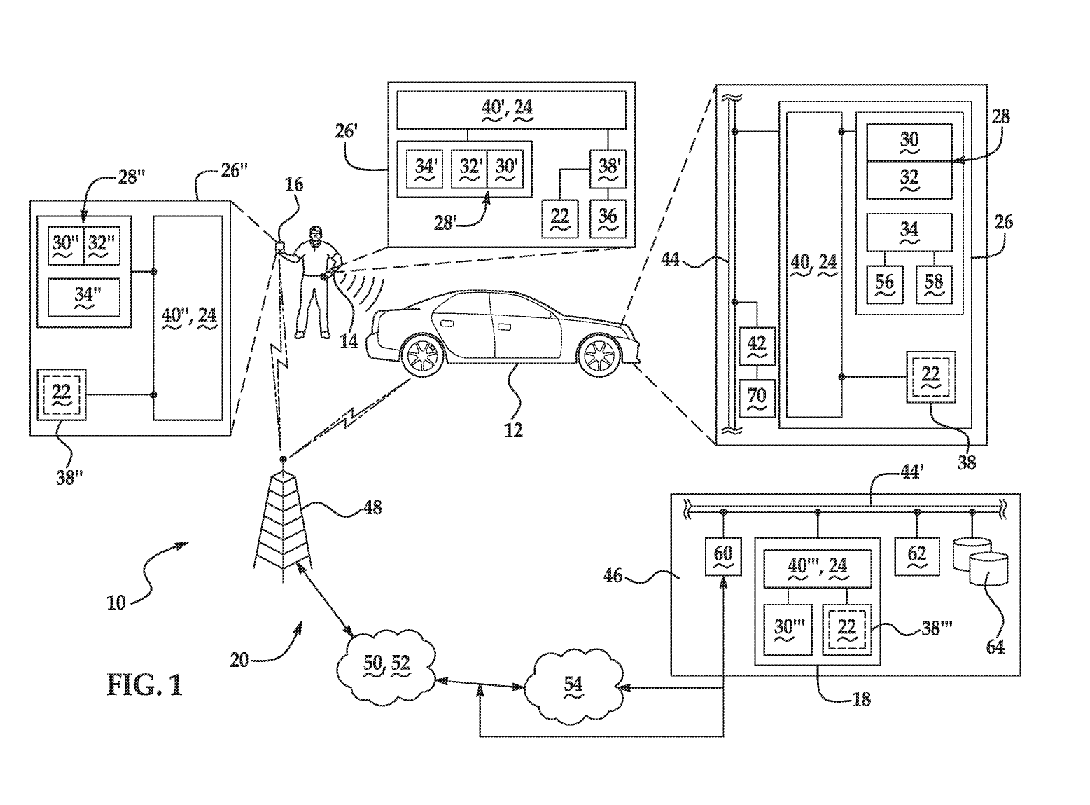

Referring now to FIG. 1, an example of the system 10 is depicted. The system 10 may include a vehicle 12, a wearable device 14, a mobile communications device 16, and/or a server 18 (which may be part of a center 46 that provides back-end services to the vehicle 12). In the example shown in FIG. 1, each component 12, 14, 16, 18 is capable of communicating with one or more of the other components 12, 14, 16, 18 using low energy, short range wireless communication technology, dedicated short range communications technology, and/or a wireless carrier/communication system 20.

In some examples disclosed herein, a vehicle system application follows a model/view/controller design pattern. The model 22 contains the specific data (e.g., a list of hand gestures and the distinct vehicle function associated with each) and business logic for the application. The view 36 is an interface on the wearable device 14 that allows a user to view the data and to input a hand gesture. The controller 24 performs operations on the data. The view 36 visually provides data, information, options, etc. to the user of the wearable device 14, and also enables the user to interact with the application using swipes, gestures, taps, touches, tables, etc. The controller 24 is between the model 22 and the view 36, and acts as a dispatcher between two. More specifically, the controller 24 provides model data to the view 36, and interprets user actions (received at the view 36), such as hand gestures. The controller 24 depends on the view 36 and the model 22. The view 36 is part of the wearable device 14.

In some examples disclosed herein, the model 22 and controller 24 may be on an external computing device (not shown). As one example, the computing device may be hosted on the mobile device 16. In another example, the computing device may be hosted on the server 18. In still another example, the computing device may be hosted on a vehicle communications platform (VCP) 26 of the vehicle 12. In any of the instances where the computing device is hosted on a device external to the wearable device 14, the hosting device (e.g., mobile device 16) may act as a server, and the wearable device 14 may act as a thin client. In some instances, in addition to having access to the data contained in the model 22, the hosting device may also be in communication with a back-end system (e.g., components at center 46) to obtain additional data (e.g., additional hand gestures and the distinct vehicle function associated with them, etc.) that is not contained in the model 22.

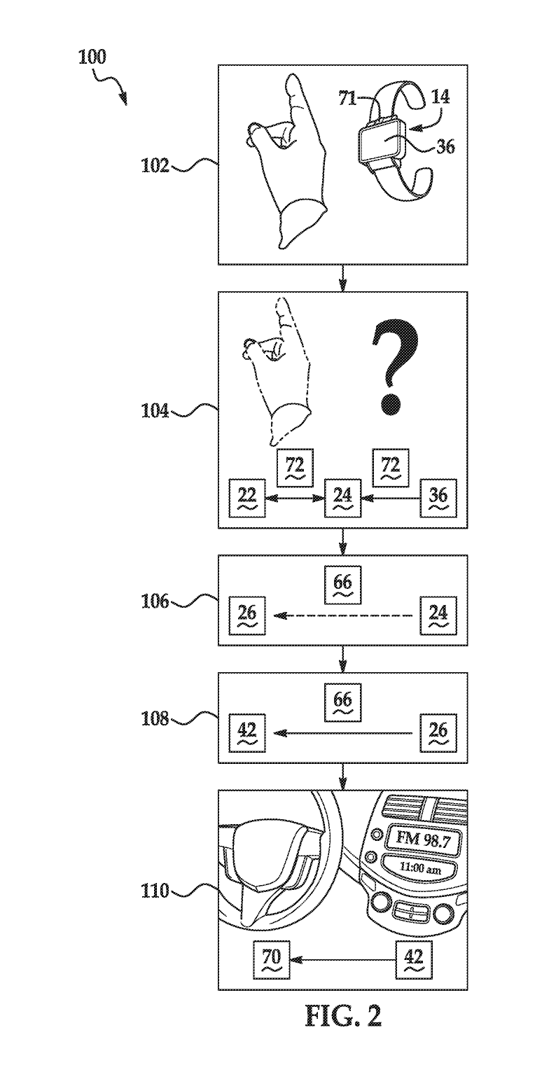

In other instances, the wearable device 14 may contain the view 36, controller 24, and model 22. In these instances, the wearable device 14 is capable of storing the data, providing the interface, and performing operations on the data. In these instances, the in-vehicle system request 66 (shown in FIG. 2) may be transmitted directly to the vehicle 12 from the wearable device 14, which functions in the same manner as the computing device described herein. In these instances then, mobile device 16 and the server 18 are not part of the system 10.

In some of the examples disclosed herein, data (e.g., in-vehicle system request(s) 66 or hand gesture data 72 (shown in FIG. 2), etc.) may be transmitted to, from, and/or between communication component(s) of the vehicle 12, the wearable device 14, the mobile device 16 and/or the server 18 using the carrier/communication system 20. Some of these communication links between the various components are shown as lightning bolts and arrows in FIG. 1.

In an example, the carrier/communication system 20 is a two-way radio frequency (RF) communication system. The carrier/communication system 20 may include one or more cell towers 48 or satellites (not shown). It is to be understood that the carrier/communication system 20 may also include one or more base stations and/or mobile switching centers (MSCs) 50 (e.g., for a 2G/3G network), one or more evolved Node Bs (eNodeB) and evolved packet cores (EPC) 52 (for a 4G (long-term evolution, LTE) network), and/or one or more land networks 54. The carrier/communication system 20 may be part of a cellular radio environment or a satellite radio environment, which may include a variety of wireless network providers (which include mobile network operator(s), not shown), utilizing the same or a variety of radio access technologies. While several examples have been provided, it is to be understood that the architecture of the wireless carrier/communication system 20 may be GSM (global system for mobile telecommunications), CDMA2000, UMTS (universal mobile telecommunications system), LTE, or some other available architecture.

Low energy short range wireless communications may be suitable for communication between, for example, the vehicle 12 and the wearable device 14 or the wearable device 14 and the mobile device 16. Each of the vehicle 12, the wearable device 14, and the mobile device 16 includes a respective communications platform, referred to herein as the vehicle communications platform (VCP) 26, the wearable device communications platform (WDCP) 26′, and the mobile device communications platform (MDCP) 26″. When the computing device is hosted by the vehicle 12, the computing device may be implemented as the VCP 26. When the computing device is hosted by the mobile device 16, the computing device may be implemented as a communications platform 26′ of the mobile device 16.

The vehicle communications platform 26 may be in low energy, short range wireless communication with the wearable device communications platform 26′, and the wearable device communications platform 26′ may be in low energy, short range wireless communication with the mobile device communications platform 26″. The communications platforms 26, 26′, 26″ may communicate via any low energy, short range wireless communication technology. Low energy, short-range wireless communication technology refers to a wireless personal area network technology that provides reduced power consumption while maintaining a better or similar communication range (e.g., 100 meters or less) when compared to other short-range wireless technology standards. An example of the low energy, short-range wireless communication technology is BLUETOOTH® low energy (i.e., BLUETOOTH® LE (BLE) or BLUETOOTH® Smart). BLUETOOTH® low energy enabled devices consume a fraction of the power of conventional BLUETOOTH® enabled devices, while maintaining a better or similar communication range.

Each of the communications platforms 26, 26′, 26″ is equipped with a low energy, short-range wireless communication module 28, 28′, 28″. In one example, each of the low energy, short-range wireless communication modules 28, 28′, 28″ is a BLE module. Each of these modules 28, 28′, 28″ includes a respective transceiver 30, 30′, 30″ (or a transmitter and a receiver) and a respective node 32, 32′, 32″. Each transceiver 30, 30′, 30″ includes a respective signal emitter for transmitting signals/data and a respective signal receiver for receiving signals/data. The respective nodes 32, 32′, 32″ allow the modules 28, 28′, 28″ to communicate, via a short-range wireless communication link, with other device(s) that are low energy, short-range wireless communication enabled. The node 32, 32′, 32″ provides the autonomous communication link with the other enabled device(s) after an initial pairing between the two modules 28, 28′, 28″. The nodes 32, 32′, 32″ may be standalone chipsets/modems, or may be integrated as part of the transceiver 30, 30′, 30″, or may be integrated as part of any other circuit in the module 28, 28′, 28″.

It is to be understood that each of the modules 28, 28′, 28″ has a unique identifying code (e.g., a wireless connection key) that is used to pair the respective module 28, 28′, 28″ with a module of another enabled device. Two devices are paired with each other when the modules 28, 28′, 28″ of those devices exchange their unique identifying codes with each other. For example, the module 28 in the vehicle 12 and the module 28′ in the wearable device 14 are paired when they exchange their unique identifying codes with each other. This enables the vehicle 12 and the wearable device 14 to communicate typically under a secured connection (e.g., autonomous communication link).

As a more specific example, initial pairing may involve setting the wearable device 14 to a short range wireless discovery mode (such as by selecting, on the wearable device 14, a discovery mode function as a menu option, icon, or the like). While in the discovery mode, other devices configured for low energy, short-range wireless communications (such as the vehicle 12 including module 28 and/or the mobile device 16 including module 28″) are allowed to detect the presence of the wearable device 14. When the module 28 and/or 28″ locates the wearable device 14, the wearable device 14 automatically provides the type of device it is (e.g., a smart watch, a smart bracelet, etc.) and its short range wireless connection name. The wearable device 14 may then prompt the user to enter a security code/password, and then the unique identifying code of the wearable device 14 is sent to the module 28 of the vehicle 12 and/or the module 28″ of the mobile device 16. Upon receiving the unique identifying code, the module 28 and/or 28″ sends its own unique identifying code to the module 28′ of the wearable device 14 to ultimately pair the two devices 14 and 12 or 14 and 16. After the initial pairing process, the respective devices 12 or 16, 14 may automatically establish the communication link without having to go through the initial pairing process again, as long as the devices 14 and 12 or 14 and 16 are within short range of one another.

An Internet connection may also be utilized for the transmission of in-vehicle system request(s) 66, hand gesture data 72, etc. The communications platforms 26, 26′, 26″ may communicate via dedicated short range communications (DSRC), or WI-FI™. The transmission of in-vehicle system request(s) 66, hand gesture data 72, etc. may be made using the carrier/communication system 20, either through the vehicle's Internet connection (e.g., when the vehicle 12 is equipped with a 4G long-term evolution, LTE, or other suitable Internet connection), through the mobile device's cellular and Internet connection, or through the wearable device's cellular and Internet connection. When WI-FI™, dedicated short range communications, and various classes thereof are utilized, the communications platforms 26, 26′, 26″ may also utilize a cellular adapter (e.g., shown as 34 in the VCP 26, 34′ in the WDCP 26′ and 34″ in the MDCP 26″).

In addition to the short-range wireless communication module 28, 28′, 28″ each of the vehicle 12, the wearable device 14, and the mobile device 16 includes several other components. The vehicle 12 will now be described separately from the wearable device 14 and the mobile device 16.

In the examples disclosed herein, the vehicle 12 may be a car, motorcycle, truck, or recreational vehicle (RV). The vehicle 12 is equipped with suitable hardware and computer readable instructions/code that allow it to communicate (e.g., transmit and/or receive voice and data communications) over the carrier/communication system 20 and to enable and disable the low energy, short-range wireless communication module 28. In the examples disclosed herein, the vehicle 12 may be a listening/scanning device. As such, the low energy, short-range wireless communication module 28 may be in a scanning mode where it continuously scans for a signal from another enabled device.

At least some of the hardware and computer readable instructions/code are embodied in the VCP 26. In an example, the VCP 26 is an on-board vehicle dedicated communications and entertainment device. In another example (not shown), the VCP 26 is an on-board vehicle dedicated communications device (e.g., a telematics unit), and the vehicle 12 includes a separate on-board vehicle dedicated entertainment device (e.g., an infotainment unit). Whether integrated into a single unit (e.g., VCP 26) or included as separate units, the on-board vehicle dedicated communications and entertainment device(s) include hardware components that are capable of running computer readable instructions/code, which are embodied on non-transitory, tangible computer readable media.

The VCP 26 may provide a variety of services. One example of these services includes the VCP 26 transmitting an in-vehicle system request 66 a control module (CM) 42. Several other examples of the services may include, but are not limited to: turn-by-turn directions and other navigation-related services provided in conjunction with a location detection unit; airbag deployment notification and other emergency or roadside assistance-related services; and infotainment-related services where music, Web pages, movies, television programs, videogames and/or other content is downloaded by the VCP 26 via a vehicle bus system 44 and an audio bus system (not shown). The listed services are by no means an exhaustive list of all the capabilities of the VCP 26, but are simply an illustration of some of the services that the VCP 26 is capable of offering.

The VCP 26 may be used for vehicle communications. In the examples disclosed herein, the VCP 26 may communicate with the server 18 in order to receive an in-vehicle system request 66. These, as well as some other, vehicle communications utilize radio or satellite transmissions to establish a voice channel with the carrier/communication system 20 such that both voice and data transmissions may be sent and received over the voice channel. In some instances, vehicle communications are enabled through the VCP 26 via the cellular adapter 34, which includes a cellular chipset/component 56 for voice communications and a data transmission system 58 for data transmission.

The cellular chipset/component 56 of the VCP 26 may be an analog, digital, dual-mode, dual-band, multi-mode and/or multi-band wireless transceiver. The cellular chipset/component 56 uses one or more prescribed frequencies in standard analog and/or digital bands in the current market for cellular systems. Any suitable protocol may be used, including digital transmission technologies, such as TDMA (time division multiple access), CDMA (code division multiple access), W-CDMA (wideband CDMA), FDMA (frequency-division multiple access), OFDMA (orthogonal frequency-division multiple access), etc.

In an example, the data transmission system 58 may include a packet builder, which is programmed to make decisions about what packet to send (e.g., bandwidth, data to include, etc.) and to actually build a packet data message. In another example, the data transmission system 58 may include a wireless modem, which applies some type of encoding or modulation to convert the digital data so that it can communicate through a vocoder or speech codec incorporated in the cellular chipset/component 56. It is to be understood that any suitable encoding or modulation technique that provides an acceptable data rate and bit error may be used with the examples disclosed herein. While examples have been provided, it is to be understood that any suitable data transmission system 58 may be used.

The cellular adapter 34 of the vehicle 12 may also provide a portable hotspot, which taps into the cellular network (e.g., a 4G network) and then wirelessly shares its data connection with another short-range wireless communication enabled (e.g., Wi-Fi enabled) device.

The VCP 26 may also be configured for short-range wireless communication technologies in addition to the low energy, short-range wireless communication technology. Examples of other short-range wireless communication technologies includes standard BLUETOOTH® and various classes thereof, dedicated short-range communications (DSRC), or WI-FI™ and various classes thereof.

The VCP 26 also includes an electronic processing device 40 operatively coupled to one or more types of electronic memory 38. In an example, the electronic processing device 40 is a microprocessor. In other examples, the electronic processing device 40 may be a micro controller, a controller, and/or a host processor (e.g., for the computing device). In another example, electronic processing device 40 may be an application specific integrated circuit (ASIC). The electronic memory 38 of the VCP 26 may be an encrypted memory that is configured to store i) computer readable instructions/code to be executed by the processor 40, ii) data associated with the various systems of the vehicle 12 (i.e., vehicle data, VIN, etc.), iii) the model 22, and/or the like. The electronic memory 38 may be a non-transitory, tangible computer readable media (e.g., RAM).

The VCP 26 is operatively connected to the vehicle bus system 44. The vehicle bus system 44 may utilize a variety of networking protocols, such as a controller area network (CAN), a media oriented system transfer (MOST), a local interconnection network (LIN), an Ethernet, TCP/IP, and other appropriate connections such as those that conform with known ISO, SAE, and IEEE standards and specifications, to name a few. The vehicle bus system 44 enables the vehicle 12 to send signals (e.g., real-time bus messages, alert notifications) from the VCP 26 to various units of equipment and systems (e.g., a control module (CM) 42). The vehicle bus system 44 also enables the vehicle 12 to receive signals at the VCP 26 from various units of equipment and systems. An example of a signal transmitted by the vehicle bus 44 includes an in-vehicle system request 66 from the VCP 26 to the CM 42. Another example of a signal transmitted by the vehicle bus 44 includes an in-vehicle system command 68 from the CM 42 to an in-vehicle system 70.

The control module (CM) 42 may be any electronic control unit. The CM may control any function related to the vehicle 12. Examples of the control module 42 include a body control module and/or a powertrain control module. Examples of systems the CM 42 may control include a trunk open/close system, a lift gate control system, a window up/down system, a sunroof open/closed system, an interior lighting system, a door lock/unlock system, an ignition/power system, an infotainment system, and a climate control system. In one example, the CM 42 includes the body control module, which controls the trunk open/close system, the lift gate control system, the window up/down system, the sunroof open/closed system, the interior lighting system, the door lock/unlock system, the infotainment system, and the climate control system, and the powertrain control module, which controls the ignition/power system. The CM 42 is operatively connected to the vehicle bus 44, and uses the vehicle bus 44 to send in-vehicle system command(s) 68 to the in-vehicle system(s) 70. The in-vehicle system(s) 70 are responsive to the in-vehicle system command(s) 68 and implement the appropriate vehicle function(s).

As mentioned above, examples of the system 10 include the wearable device 14 and/or the mobile device 16. In the examples disclosed herein, it is to be understood that the wearable device 14 may be a smart watch, smart helmet, smart bracelet, smart glasses, etc. As described above, the wearable device 14 is either low energy, short range wireless communication enabled or cellular/Internet wireless communication enabled. In the examples disclosed herein, the mobile device 16 may be any mobile device, including a smart phone, such as a GSM/LTE phone or a GSM/CDMA/LTE phone. In other examples, the mobile device 16 may be any portable device that has a mobile device communication platform (MDCP) 26″. Examples of other mobile devices 16 include a tablet computer, a key fob, etc., each of which may be, for example, GPS, cellular/Internet wireless communication enabled, and low energy, short range-wireless communication enabled.

As shown in FIG. 1 and mentioned above, the wearable device 14 and mobile device 16 each have a communications platform, the WDCP 26′ and the MDCP 26″, which include the low energy, short-range wireless communication modules 28′ and 28″ respectively. As discussed above, the low energy, short-range wireless communication capability (e.g., BLUETOOTH® LE or Smart, and variations thereof) enables the wearable device 14 and the mobile device 16 to communicate with other low energy, short-range wireless communication devices (e.g., each other and/or the vehicle 12). In the examples disclosed herein, the wearable device 14 and/or the mobile device 16 may be a listening/scanning device. As such, the low energy, short-range wireless communication module 28′ and/or 28″ may be in a scanning mode where it continuously scans for an advertising event signal or another signal from another enabled device.

The MDCP 26″ and/or the WDCP 26″ may also include a cellular adapter 34″, 34′. The cellular adapter 34″ of the mobile device 16 may include a cellular chipset/component for voice communications and a data transmission unit for data transmission. Using the cellular adapter 34″, the mobile device 16 is capable of making cellular or satellite connections and/or Internet connections (over the wireless carrier/communication system 20). The cellular adapter 34″ of the mobile device 16 may also provide a portable hotspot, which taps into the cellular network (e.g., a 4G network) and then wirelessly shares its data connection with another short-range wireless communication enabled (e.g., Wi-Fi enabled) device.

Some examples of the cellular adapter 34′ of the wearable device 14 may include a cellular chipset/component for voice communications and a data transmission unit for data transmission (i.e., the cellular adapter 34′ may be able to support cellular communication and/or Internet communication, e.g., on a 4G network).

Other examples of the cellular adapter 34′ of the wearable device 14 may be capable of dedicated short range communications (DSRC) or WI-FI™, but not capable of establishing its own cellular network connections. In these instances, the cellular adapter 34′ of the wearable device 14 may utilize the data connection provided by the portable hotspot of the vehicle 12 or the mobile device 16 to transmit data over the wireless carrier/communication system 20.

The wearable device 14 and the mobile device 16 also include physical hardware (e.g., a microprocessor 40′, 40″) and computer readable instructions stored in an electronic memory 38′, 38″. The microprocessors 40′ and 40″ of the wearable device 14 and the mobile device 16 (respectively) may be similar to processor 40 of the vehicle 12, and are capable of executing the computer readable instructions stored in the memory 38′, 38″ (respectively), which may be similar to the electronic memory 38.

In the system 10, the vehicle 12, the wearable device 14, and/or the mobile device 16 may be in communication with the server 18, which may be part of a center 46 that provides back-end services to the vehicle 12. As an example, the vehicle 12 or the mobile device 16 may host the computing device (including model 22 and controller 24) and may communicate with the server 18 to receive data pertaining to hand gestures and the vehicle function associated with the hand gestures. As another example, the server 18 may host the computing device (including model 22 and controller 24), may communicate with the wearable device 14 to receive the hand gesture data 72, and may communicate with the vehicle 12 to transmit the in-vehicle system request 66 thereto.

It is to be understood that the center 46 shown in FIG. 1 may be any central or remote facility, manned or unmanned, mobile or fixed, to or from which it is desirable to exchange voice and data communications. As such, a live advisor (not shown) may be physically present at the center 46 or may be located remote from the center 46 while communicating therethrough.

The center 46 shown in FIG. 1 may also be virtualized and configured in a Cloud Computer, that is, in an Internet-based computing environment. For example, the server 18 (and other computing equipment) may be accessed as a Cloud platform service, or PaaS (Platform as a Service), utilizing Cloud infrastructure rather than hosting server 18 at the center 46. In these instances, the server 18 (and other center 46 components) may be virtualized as a Cloud resource. The Cloud infrastructure, known as IaaS (Infrastructure as a Service), typically utilizes a platform virtualization environment as a service, which may include components such as processor(s) 40′″, database(s) 64, server 18, and other computer equipment. In an example, the real-time services performed by the server 18 disclosed herein may be performed in the Cloud via the SaaS (Software as a Service).

As shown in FIG. 1, the server 18 includes the processor 40′″, and the center 46 may also include additional processor(s) 62. The processors 40′″, 62 may be a controller, a host processor (e.g., for the computing device), an ASIC, or a processor working in conjunction with a central processing unit (CPU). The processor 40′″ is capable of executing the computer readable instructions that are stored on the electronic memory 38″ ‘.

The server 18 also includes a server communication transceiver 30’″ that may be in selective communication with the VCP 26, the WDCP 26′, and/or the MDCP 26″. The server communication transceiver 30′″ may be any suitable data transmission system that is capable of sending and/or receiving data communications over the carrier/communication system 20. For example, the server communication transceiver 30′″ is capable of receiving the hand gesture data 72 from the wearable device 14 (e.g., through an Internet connection of the vehicle 12 or mobile device 16). The server communication transceiver 30′″ can also transmit the in-vehicle system request 66 to the VCP 26 of the vehicle 12. The server 18, hosting the computing device, may reference a list of hand gestures and the vehicle functions associated with the hand gestures (stored in the memory 38′″ or a database 64) to authenticate the hand gesture data 72.

The database(s) 64 may be designed to store vehicle record(s), subscriber/user profile records, or any other pertinent subscriber and/or vehicle information and/or mobile communications device information. In an example, the database(s) may be configured to store the user profile, which may contain personal information of the subscriber (e.g., the subscriber's name, a list of personalized hand gesture(s) and the vehicle function(s) associated therewith, a billing address, a home phone number, a cellular phone number, etc.) and/or information of the vehicle 12 (e.g., identification number, etc.). It is to be understood that the databases 64 may allow the center 46 to function as a repository for data collected from the vehicle 12. In some instances, another facility may function as a repository for the collected data (e.g., a customer relationship management system (not shown) associated with the center 46 whose database(s) the server 18 can access).

As illustrated in FIG. 1, the various center components may be coupled to one another via a network connection or bus 44′, such as one similar to the vehicle bus 44 previously described.

In addition to the server 18, the center 46 may also include other components, such as additional processor(s) 62 and/or switch(es) 60. In some instance, the center 46 may also include advisor(s) (not shown). The additional processor(s) 62, which may be used in conjunction with telecommunication and computer equipment (not shown), may generally be equipped with suitable software and/or programs enabling the processor(s) 62 to accomplish a variety of center functions or tasks. The telecommunication and computer equipment (including computers) may include a network of servers (including server 18) coupled to both locally stored and remote databases (e.g., database 64) of any information processed. The switch(es) 60 may be private branch exchange (PBX) switch(es). The switch 60 routes incoming signals so that voice transmissions are usually sent to either a live advisor or an automated response system, and data transmissions are passed on to a modem or other piece of equipment (e.g., a communications module) for demodulation and further signal processing. Hand gesture data 72 from the wearable device 14 may be transmitted to the server 18.

Different components of the system 10 may be used to perform different examples of the method for controlling the in-vehicle system 70. The short range wireless communications and/or Internet communications as previously described are utilized in the example of the method 100 shown in FIG. 2. Throughout the discussion of the method 100, it is to be understood that the communications platforms 26, 26′ and/or 26, 26″ and/or 26′, 26″ may communicate with one another, and that the computing device (including model 22 and controller 24) may be implemented in the wearable device 14, the vehicle 12, the mobile device 16, or the server 18.

As shown at reference numeral 102 of FIG. 2, the method 100 includes the wearable device 14 (in this example, a smart watch) recognizing a hand gesture. In some examples, wearable device 14 may launch the view 36 of the vehicle system application in response to establishing a connection between the wearable device 14 and the vehicle 12 through low energy, short-range wireless communication modules 28′, 28. In other examples, the user may launch the view 36 of the vehicle system application. It is to be understood that the user may launch the view 36 from any location and does not need to be near the vehicle 12 to do so. The ability of the user to launch the view 36 from anywhere improves the functioning of the vehicle 12 by enabling the user to control in-vehicles system(s) 70 from any location.

The user may make a hand gesture that is recognizable by the view 36. In an example, the view 36 includes a camera 71 generally positioned on the wearable device 14 so that it can capture the hand gesture(s) of the user. In this example, the user may perform the hand gesture in view of the camera 71. In another example, the view 36 includes a capacitive sensor (not shown) that may take the form of a gesture-based touchscreen. In this example, the user performs the hand gesture on the surface of the touchscreen of the wearable device 14.

Recognition of the wearer's hand gesture(s) may be accomplished utilizing manufacturer settings for recognizing basic hand gestures. These manufacturer settings may be altered by training the view 36, e.g., by running the view 36 through several hand gestures of the wearer to capture and save (e.g., in model 22) those hand gestures as being unique to the wearer. As such, the hand gestures may be considered an authentication of the hand gesture as belonging to that wearer.

As shown in FIG. 2, the user uses a hand gesture to select an in-vehicle system action that is to be performed or implemented by the in-vehicle system 70 associated with that action. In the example shown at reference numeral 102, the hand gesture is a physical hand motion performed by, e.g., the wearer of the wearable device 14 in order to initiate a particular action by a particular in-vehicle system 70. It is to be understood that the hand gesture may be performed using any hand motions. For example, the user may use a thumbs up gesture or a thumbs down gesture to indicate that a window should be raised or lowered or to indicate that the volume of an infotainment system should be turned up or down. The hand gesture may include a single hand gesture or a plurality of hand gestures. As an example of a single hand gesture, the user may use a number one hand gesture (forefinger extended straight and thumb, middle, ring, and pinky fingers curled into the palm) to indicate a preset radio station or to indicate that the trunk or lift gate should be opened. As an example of a plurality of hand gestures, the user may use a thumbs down gesture to indicate that a window should be lowered, a number one hand gesture to indicate which window should be lowered, and an okay hand gesture (i.e., connecting the thumb and forefinger in a circle and extending the middle, ring, and pinky fingers straight) to indicate that the window should be opened all the way. In another example of a plurality of hand gestures, the user may wave his/her hand upward to indicate that something should be opened, and wave his/her hand to the left or right to indicate that it is a door or the trunk that should be opened.

While not shown in FIG. 2, in some examples, prior to performing the hand gesture to select an in-vehicle system action, the user may first be required to perform an initiation (e.g., an authentication) gesture. Once the initiation gesture is recognized by the view 36, the view 36 may then recognize other hand gestures associated with vehicle functions. In other examples, the view 36 may be able to recognize hand gestures associated with vehicle functions without first recognizing an initiation gesture.

Upon recognizing the hand gesture(s), the view 36 transmits the hand gesture data 72 to the controller 24 (which, as described above, may be part of the wearable device 14, or the mobile device 16, or the vehicle 12, or the server 18). The controller 24 authenticates the hand gesture by identifying the hand gesture in a list of approved hand gestures, and identifying a distinct vehicle function associated with that hand gesture. The controller 24 is programmed to utilize the received hand gesture data 72 as a query in the library or data table of the model 22 to determine whether the recognized hand gesture is present in the library or data table (i.e., is an authentic or approved hand gesture). When the model 22 is present on the mobile device 16, the vehicle 12, or the server 18, the library or data table may have more stored hand gestures than when the model 22 is present on the wearable device 14. The model 22 located on the server 18 may provide the largest and richest set of the gestures for comparison.

In some examples, when the recognized hand gesture is not present in the list of approved hand gestures, the controller 24 can transmit a message for display on the view 36 indicating that the hand gesture is not a match and/or prompting the user to reenter the hand gesture. In other examples, when the recognized hand gesture is not present in the list of approved hand gestures, the controller 24 can transmit a message for display on the view 36 prompting the user to assign a vehicle function to the gesture. In these examples, the controller 24 may add the recognized hand gesture and the vehicle function, input by the user at the view 36, to the list of approved hand gestures. When the recognized hand gesture is present in the list of approved hand gestures, the controller 24 also identifies the distinct vehicle function associated with that hand gesture. Within the library or data table, the hand gestures may be linked to or associated with a particular in-vehicle system action. As such, using the hand gesture data 72, the controller 24 is programmed to authenticate the hand gesture and to identify the vehicle function that is linked to/associated with the hand gesture. The authentication of the hand gesture is shown at reference numeral 104.

Once the hand gesture is authenticated, the controller 24 transmits an in-vehicle system request 66 to the VCP 26. Based upon the identified vehicle function, the controller 24 determines, generates, and transmits the appropriate in-vehicle system request 66. The in-vehicle system request 66 indicates to the VCP 26 that the vehicle function, having been identified by the controller 24 as being associated with the hand gesture data 72, should be implemented in the vehicle 12. The transmission of the in-vehicle system request 66 to the VCP 26 is shown at reference numeral 106.

Upon receiving the in-vehicle system request 66, the VCP 26 transmits the in-vehicle system request 66 to an appropriate control module 42 depending upon the vehicle function that is to be performed. In the examples disclosed herein, the control module 42 may be the body control module and/or the powertrain control module. The in-vehicle system request 66 indicates to the CM 42 which vehicle function is to be initiated/implemented. The transmission of the in-vehicle system request 66 to the CM 42 is shown at reference numeral 108.

As shown at reference numeral 110, the control module 42 then sends an in-vehicle system command 68 to the appropriate in-vehicle system 70. Upon receiving the in-vehicle system request 66, the CM 42 generates an appropriate in-vehicle system command 68 for the particular in-vehicle system 70. The in-vehicle system command 68 indicates the same vehicle function that was indicated in the associated in-vehicle system request 66 received by the VCP 26 and the CM 42. The CM 42 transmits the in-vehicle system command 68 to the in-vehicle system 70, and the in-vehicle system 70 is responsive to the in-vehicle system command 68 and implements the indicated vehicle function. The implementation of the vehicle function is shown at reference numeral 110.

Implementation of the in-vehicle system command 68 may be accomplished by opening or closing a trunk of the vehicle 12 by a trunk open/close system, opening or closing a lift gate by a lift gate control system, moving a window up or down by a window up/down system, opening or closing a sunroof by a sunroof open/closed system, controlling an interior light by an interior lighting system, locking or unlocking doors of the vehicle 12 by a door lock/unlock system, starting or stopping an engine by an ignition/power system, controlling an infotainment option by an infotainment system, or controlling an in-vehicle climate setting by an in-vehicle climate control system. In the example shown at reference numeral 110 in FIG. 2, implementation of the in-vehicle system command 68 is accomplished by controlling an infotainment option by an infotainment system. Specifically, the recognized and authenticated hand gesture is associated with a preset radio station, and this preset radio station is identified in both the in-vehicle system request 66 and the in-vehicle system command 68. The in-vehicle system command 68 instructs the infotainment system to adjust the infotainment system to select and play the preset radio station.

In one example, the wearable device 14 is a smart watch and the computing device is implemented thereon. In this example, the in-vehicle system application is stored on the electronic memory 38′ of the smart watch, and the microprocessor 40′ of the smart watch, which is coupled to the electronic memory 38′, acts as the controller 24. The model 22 of in-vehicle system application is stored on the electronic memory 38′ and includes a list of a plurality of hand gestures, each hand gesture being associated with a distinct vehicle function. The microprocessor 40′ is programmed to authenticate the hand gesture. Once the microprocessor 40′ authenticates the hand gesture, the microprocessor 40′ determines the appropriate in-vehicle system request 66 and the communications platform 26′ of the smart watch transmits the in-vehicle system request 66 to the VCP 26, which transmits the in-vehicle system request 66 to the CM 42.

In another example, the computing device is implemented on the vehicle 12. In this example, the in-vehicle system application is stored on the electronic memory 38 of the vehicle 12 and the processor 40 of the vehicle 12, which is coupled to the electronic memory 38, acts as the controller 24. The model 22 of in-vehicle system application is stored on the electronic memory 38 and includes a list of a plurality of hand gestures, each hand gesture being associated with a distinct vehicle function. The view 36, implemented on the wearable device 14, transmits the hand gesture data 72 to the processor 40. The processor 40 is programmed to authenticate the hand gesture, and once the processor 40 authenticates the hand gesture, the processor 40 determines the appropriate in-vehicle system request 66 and the VCP 26 transmits the in-vehicle system request 66 to the CM 42.

In still another example, the computing device is implemented on the mobile device 16. In this example, the in-vehicle system application is stored on the electronic memory 38″ of the mobile device 16 and the microprocessor 40″ of the mobile device 16, which is coupled to the electronic memory 38″, acts as the controller 24. The model 22 of in-vehicle system application is stored on the electronic memory 38″ and includes a list of a plurality of hand gestures, each hand gesture being associated with a distinct vehicle function. The view 36, implemented on the wearable device 14, transmits the hand gesture data 72 to the microprocessor 40″. The microprocessor 40″ is programmed to authenticate the hand gesture. Once the microprocessor 40″ authenticates the hand gesture, the microprocessor 40″ determines the appropriate in-vehicle system request 66 and the MDCP 26″ transmits the in-vehicle system request 66 to the VCP 26, which transmits the in-vehicle system request 66 to the CM 42.

In still another example, the computing device is implemented on the server 18. In this example, the in-vehicle system application is stored on the electronic memory 38′″ of the server 18 and the processor 40′″ of the server 18, which is coupled to the electronic memory 38′″, acts as the controller 24. The model 22 of in-vehicle system application is stored on the electronic memory 38′″ and includes a list of a plurality of hand gestures, each hand gesture being associated with a distinct vehicle function. The view 36, implemented on the wearable device 14, transmits the hand gesture data 72 to the processor 40′″. The processor 40′″ is programmed to authenticate the hand gesture. Once the processor 40′″ authenticates the hand gesture, the processor 40′″ determines the appropriate in-vehicle system request 66 and the server 18 transmits the in-vehicle system request 66 to the VCP 26, which transmits the in-vehicle system request 66 to the CM 42.

Whether the computing device is implemented on the vehicle 12, the wearable device 14, the mobile device 16, or the server 18, the method 100 disclosed herein may be repeated when the in-vehicle system application launches, either because the user has launched the application or in response to establishing a connection between the wearable device 14 and the vehicle 12 through low energy, short-range wireless communication modules 28, 28′, and the user performs a hand gesture on the surface of the touchscreen of the wearable device 14 or in view of the camera 71 of the wearable device 14. The user may use the method 100 to implement as many vehicle functions as the user desires.

In some examples, the wearable device 14 is able to display the vehicle function implemented (in the form of a visual representation) using the view 36. In an example, the controller 24 may transmit the identified vehicle function to the WDCP 26′ upon authenticating the hand gesture. The wearable device 14 may display the vehicle function upon receiving it from the controller 24. In another example, the controller 24 may transmit a notification to the WDCP 26′ upon transmitting the in-vehicle system request 66 to the VCP 26. The wearable device 14 may display the vehicle function upon receiving the notification that the in-vehicle system request 66 was sent to the VCP 26. In still another example, the VCP 26 may transmit a notification to the WDCP 26′ once the vehicle function is implemented in the vehicle 12. The wearable device 14 may display the vehicle function upon receiving the notification that the vehicle function was implemented. The wearable device 14 may also display two or more notifications, notifying the user of the vehicle function identified, and/or notifying the user that the in-vehicle system request 66 was sent to the VCP 26, and/or notifying the user that the vehicle function was implemented.

It is to be understood that the term “communication” as used herein is to be construed to include all forms of communication, including direct and indirect communication. Indirect communication may include communication between two components with additional component(s) located therebetween.

Further, the terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween).

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

1. A system to control an in-vehicle system, comprising:
a wearable device to recognize a hand gesture;
a vehicle communications platform operatively disposed in a vehicle, the vehicle communications platform to receive an in-vehicle system request in response to authentication of the hand gesture;
a control module in communication with the vehicle communications platform, wherein the vehicle communications platform transmits the in-vehicle system request to the control module upon receiving the in-vehicle system request; and
the in-vehicle system responsive to an in-vehicle system command from the control module, wherein the control module transmits the in-vehicle system command to the in-vehicle system upon receiving the in-vehicle system request from the vehicle communications platform.

2. The system as defined in claim 1 wherein the wearable device is a smart watch including:
a smart watch communications platform to transmit the in-vehicle system request to the vehicle communications platform; and
a microprocessor operatively connected to the smart watch communications platform, the microprocessor programmed to authenticate the hand gesture.

3. The system as defined in claim 2 wherein the smart watch further includes:
an electronic memory coupled to the microprocessor; and
a vehicle system application stored on the electronic memory, the vehicle system application including a list of a plurality of hand gestures, each hand gesture associated with a distinct vehicle function.

4. The system as defined in claim 3 wherein the vehicle system application further includes computer readable instructions, executable by the microprocessor, to:
launch the vehicle system application in response to establishing a connection between the smart watch and the vehicle through low energy, short-range wireless communication modules; and
provide a visual representation of the in-vehicle system request on a display of the smart watch in response to recognizing the hand gesture.

5. The system as defined in claim 1 wherein the hand gesture is performed on a surface of a touchscreen of the wearable device or in view of a camera of the wearable device.

6. The system as defined in claim 1 wherein the in-vehicle system is selected from the group consisting of a trunk open/close system, a lift gate control system, a window up/down system, a sunroof open/closed system, an interior lighting system, a door lock/unlock system, an ignition/power system, an infotainment system, and a climate control system.

7. The system as defined in claim 1 wherein the wearable device and the vehicle communications platform are in communication through low energy, short-range wireless communication modules, through a hotspot of the vehicle, through a server, or through a mobile communications device.

8. The system as defined in claim 7 wherein the wearable device and the vehicle communications platform are in communication through the server, and wherein the server includes:
a processor;
an electronic memory coupled to the processor; and
a list of a plurality of hand gestures stored on the electronic memory, each hand gesture associated with a distinct vehicle function.

9. The system as defined in claim 7 wherein the wearable device and the vehicle communications platform are in communication through the mobile communications device, and wherein the mobile communications device includes:
a processor;
an electronic memory coupled to the processor; and
a list of a plurality of hand gestures stored on the electronic memory, each hand gesture associated with a distinct vehicle function.

10. The system as defined in claim 1 wherein the wearable device is selected from the group consisting of a smart watch, smart helmet, smart bracelet, and smart glasses.

11. A method for controlling an in-vehicle system, comprising:
recognizing, by a wearable device, a hand gesture;
authenticating the hand gesture;
transmitting an in-vehicle system request to a vehicle communications platform of a vehicle upon authenticating the hand gesture;
transmitting the in-vehicle system request to a control module; and
implementing an in-vehicle system command by the in-vehicle system in response to the in-vehicle system command from the control module.

12. The method as defined in claim 11 wherein prior to the recognizing, the method further comprises:
recognizing that the wearable device is within short range wireless communication with the vehicle communications platform; and
in response to the recognizing, launching a vehicle system application resident on an electronic memory of the wearable device.

13. The method as defined in claim 11, further comprising:
identifying a distinct vehicle function that is associated with the hand gesture through a list of a plurality of hand gestures stored on the wearable device; and
determining the in-vehicle system request to transmit based upon the identified distinct vehicle function.

14. The method as defined in claim 11, further comprising:
transmitting hand gesture data to a server;
performing the authenticating at the server by:
using the hand gesture data to identify the hand gesture in a list of a plurality of hand gestures stored on the server; and
identifying a distinct vehicle function that is associated with the hand gesture in the list of a plurality of hand gestures stored on the server; and
determining the in-vehicle system request to transmit based upon the identified distinct vehicle function.

15. The method as defined in claim 11, wherein the implementing of the in-vehicle system request is accomplished by:
opening or closing a trunk of the vehicle by a trunk open/close system;
opening or closing a lift gate by a lift gate control system;
moving a window up or down by a window up/down system;
opening or closing a sunroof by a sunroof open/closed system;
controlling an interior light by an interior lighting system;
locking or unlocking doors of the vehicle by a door lock/unlock system;
starting or stopping an engine by an ignition/power system;
controlling an infotainment option by an infotainment system; or
controlling an in-vehicle climate setting by an in-vehicle climate control system.
